(19) United States
(12) Patent Application Publication
(10) Pub. No.: US 2011/0101647 A1
(43) Pub. Date: May 5, 2011

(54) Towing Apparatus for Vehicles

(76) Inventors: Thomas M. Williams, JR., Durham, NC (US); Kamyar Kheradpir, Durham, NC (US)

(21) Appl. No.: 12/727,597

(22) Filed: Mar. 19, 2010

Related U.S. Application Data
(60) Provisional application No. 61/257,260, filed on Nov. 2, 2009.

(51) Int. Cl. B60D 1/00

(52) U.S. Cl. 280/504

(57) ABSTRACT

A towing apparatus that can be mounted to a vehicle chassis/frame or other structural member without requiring relocation of the spare tire or removal of the bumper includes a frame and a hitch apparatus secured to the frame. The frame includes an elongated base member having opposite end portions. A pair of arms extend away from the base member end portions in side by side, spaced-apart relationship. Each arm includes a mounting bracket configured to be attached to the underside of a vehicle. The hitch apparatus is secured to the base member and includes a housing and a tow bar movably disposed within the housing. The tow bar is movable relative to the housing between retracted and extended positions, and is pivotable relative to the housing when in an extended position. A locking member releasably engages the tow bar to maintain the tow bar when fully retracted.

### RELATED APPLICATION

This application claims the benefit of and priority to U.S. Provisional Patent Application No. 61/257,260 filed Nov. 2, 2009, the disclosure of which is incorporated herein by reference as if set forth in its entirety.

### FIELD OF THE INVENTION

The present invention relates generally to vehicle towing and, more particularly, to hitch assemblies for towing vehicles.

### BACKGROUND

Powered and trailed vehicles are conventionally interconnected for travel by coupling hitches involving fixed locations on the vehicles. Using ball and socket-type universal connections or pin-type connections, the required relative movement during travel is provided. The fixed locations, however, may be difficult to effect, particularly with large vehicles that prevent ready manual alignment for final coupling. When accurate alignment is not obtained, conventionally the towed vehicle is manually moved to proper position, which may require strength, dexterity and multiple personnel, often with an attendant risk of injury. As the tongue weight of the towed vehicle increases the skills and risks may be substantially increased. The problem may be particularly troublesome for large steerable wheel trailers, such as those employed by the military.

Telescoping and pivoting hitches have been proposed to allow coupling between misaligned vehicles. Most are designed for lighter weight trailers and unsuited for heavy load applications. Others provide only a length-dependent articulation reducing the accommodated zone of vehicle misalignment.

For instance, U.S. Pat. No. 4,515,387 to Shuck utilizes a tongue that must be fully extended before a tow bar can be pivoted, thereby restricting the permissible zone of vehicle misalignment. The hitch is formed of lightweight materials not suitable for heavy trailer applications. Further, the alignment torque during retraction is borne by a sliding pin connection further reducing the ability to handle heavier trailer units. U.S. Pat. No. 5,277,447 to Blaser also provides a telescoping hitch that is pivotal only in the fully extended position.

U.S. Pat. No. 5,011,176 to Eppinette discloses a telescoping arm having a pivoting outer end allowing coupling to a misaligned vehicle. The towing vehicle must be moved forwardly to align the arm sections, at which time a slidable collar is placed around the pivot connection to prevent pivoting. Thereafter, the towing vehicle is reversed to shift the arm to a retracted locked towing position. The need for forward movement, which is not always possible or convenient, and the multiple manual steps for achieving final coupling may be disadvantageous.

U.S. Pat. No. 5,322,315 to Carsten discloses a fixed pivot arm having a telescoping outer end mounted on the towing vehicle. After coupling, the towing vehicle must be moved forwardly for aligning and locking the pivoting arm and thereafter rearwardly for locking the telescoping arm. U.S. Pat. No. 6,357,779 to Mok et al. also provides a fixed pivot arm having a telescoping outer end that requires forward movement for vehicle alignment and rearward movement for retraction and locking.

U.S. Pat. No. 6,328,326 to Slatten discloses a hitch tongue that is slidably and pivotally supported on a housing for coupling misaligned vehicles. The tongue and housing have complementary camming surfaces for nested alignment in a locked position. The camming surfaces provide limited aligning torque precluding usage on heavier trailer applications.

After market trailer hitch systems have been available for some time for vehicles such as pickup trucks. These systems conventionally are mounted to a truck frame using brackets that can be coupled to the frame of a truck. Unfortunately, the truck bumper is often required to be removed, and a replacement bumper, typically of universal application, is installed with the hitch assembly. For cost reasons and aesthetic reasons, many vehicle owners do not want to replace their bumpers when installing a trailer hitch.

U.S. Pat. Nos. 6,139,042 and 6,250,664 to Tetrick describe mounting structures for a conventional truck cushion hitch assembly in which the hitch assembly is mounted to the frame of a truck at a position below the original bumper of the truck by a weldment called a carrier frame. The Tetrick mounting structure is configured such that the original bumper can be retained and avoids the cost of a replacement bumper. Unfortunately, the Tetrick mounting structures utilize transverse structural members that may interfere with the spare tire storage location of many conventional pickup trucks, and may inhibit removal of a spare tire from the storage location. As such, the Tetrick device may require the spare tire to be removed and relocated to another area of the vehicle. For various reasons including convenience, vehicle owners may not want to have to relocate a spare tire to another vehicle location.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, a towing apparatus includes a frame configured to be mounted to a the underside of a vehicle, such as to a chassis/frame or other structural member(s), and a hitch apparatus secured to the frame. The frame includes an elongated base member having opposite end portions. A pair of arms extend away from the base member end portions in side by side, spaced-apart relationship. Each arm includes a mounting bracket configured to be attached to a vehicle. In some embodiments, each arm has a substantially flat web portion with a free edge portion angled to form the mounting bracket. The mounting bracket of each arm includes one or more openings formed therein that facilitate attaching the mounting bracket to a vehicle. In some embodiments each arm may include multiple mounting brackets in adjacent, spaced-apart relationship. In some embodiments, the base member can have an arcuate shape.

The hitch apparatus is secured to the base member and includes a housing and a tow bar movably disposed within the housing. The tow bar is movable relative to the housing between retracted and extended positions, and is pivotable relative to the housing when in an extended position. The housing includes a longitudinally extending forwardly opening cavity with a restricted opening. The tow bar has a front portion and a rear portion connected by a center portion. The rear portion has a width greater than the restricted opening such that the rear portion cannot be extended through the opening. The tow bar center portion includes outwardly diverging curvilinear edge portions that cooperate with the restricted opening such that an extent to which the tow bar can pivot relative to the housing progressively increases as the tow bar is progressively extended. In some embodiments, a hitch box is secured to the tow bar front portion, wherein the hitch box is configured to receive a coupling apparatus therein. In other embodiments, the tow bar front portion includes an opening formed therethrough, and a coupling apparatus, such as a tow ball, is secured to the tow bar via the opening.

A locking member is operably secured to the frame that releasably engages the tow bar to maintain the tow bar in a retracted position. The tow bar has an opening formed therethrough, and the locking member is retractably extendable through the opening to maintain the tow bar in the retracted position. In some embodiments, a biasing member, such as a spring, compressively biases the locking member toward the tow bar such that when the tow bar is moved to the fully retracted position, the locking member is urged into the tow bar opening. When the locking member is retracted from the opening and the tow bar is in an extended position, the locking member is urged into engagement with the surface of the tow bar.

According to some embodiments of the present invention, a towing apparatus includes a U-shaped frame with a hitch apparatus secured thereto. The U-shaped frame has an elongated base member with opposite end portions, and a pair of arms extending away from the base member end portions in side by side, spaced-apart relationship. Each arm has a substantially flat web portion with a free edge portion angled to form a mounting bracket configured to be attached to the underside (e.g., to a chassis/frame, other structural member(s), etc.) of a vehicle. The web portion of each arm includes an opening, and a respective base member end portion extends through the opening of a respective arm and is secured thereto. The hitch apparatus is secured to the base member, and includes a housing and a tow bar movably disposed within the housing. The tow bar is movable relative to the housing between retracted and extended positions, and is pivotable relative to the housing when in an extended position. A locking member is operably secured to the frame and releasably engages the tow bar to maintain the tow bar in a retracted position. In some embodiments, the locking member includes a handle. The handle may be movably secured to the frame and configured to disengage the locking member from the tow bar in response to user activation.

According to some embodiments of the present invention, a vehicle includes a body and a spare tire removably mounted to an underside of the vehicle body. A towing apparatus is secured to the underside of the vehicle such that the towing apparatus does not interfere with access to the spare tire. The towing apparatus includes a frame having an elongated base member with opposite end portions, and a pair of arms extending away from the base member end portions in side by side, spaced-apart relationship such that the frame has a U-shaped configuration that extends around the spare tire. Each arm includes a mounting bracket attached to the underside (e.g., to the chassis/frame or other structural member(s), etc.) of the vehicle. A hitch apparatus is secured to the base member, and includes a housing and a tow bar movably disposed within the housing. The tow bar is movable relative to the housing between retracted and extended positions, and is pivotable relative to the housing when in an extended position.

In some embodiments, the housing has a longitudinally extending forwardly opening cavity with a restricted opening. The tow bar has a front portion and a rear portion connected by a center portion, and the rear portion has a width greater than the restricted opening such that the rear portion cannot be extended through the opening. In some embodiments, the center portion of the tow bar has outwardly diverging curvilinear edge portions that cooperate with the restricted opening such that an extent to which the tow bar can pivot relative to the housing progressively increases as the tow bar is progressively extended.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

FIG. 1 is a top perspective view of a towing apparatus, according to some embodiments of the present invention.

FIG. 2 is a partial top plan view of the towing apparatus of FIG. 1.

FIG. 3A is a cross-sectional view of the towing apparatus of FIG. 2 taken along lines 3A-3A.

FIG. 3B is a cross-sectional view of the towing apparatus of FIG. 2 taken along lines 3B-3B.

FIG. 4 is a top perspective view of a locking member for the towing apparatus of FIG. 1, according to some embodiments of the present invention.

FIG. 5 is a top plan view of a tow bar for the towing apparatus of FIG. 1, according to some embodiments of the present invention.

FIG. 6 is a bottom perspective view of the tow bar of FIG. 5 with a tow ball attached thereto.

FIGS. 7-9 are partial cut-away plan views of the towing apparatus of FIG. 1 illustrating movement of the tow bar relative to the hitch apparatus housing, according to some embodiments of the present invention.

FIG. 10 is a top perspective view of a towing apparatus, according to other embodiments of the present invention.

FIG. 11A is a partial cross-sectional view of the towing apparatus of FIG. 10 illustrating the tow bar fully retracted and engaged with the locking member.

FIG. 11B illustrates the tow bar of FIG. 11A in an extended position.

FIG. 12 is a partial perspective view of a vehicle having the towing apparatus of FIG. 1 mounted to an underside thereof, according to some embodiments of the present invention.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain components or features may be exaggerated for clarity, and broken lines illustrate optional features or elements unless specified otherwise. In addition, the sequence of operations (or steps) is not limited to the order presented in the figures and/or claims unless specifically indicated otherwise. Features described with respect to one figure or embodiment can be associated with another embodiment of figure although not specifically described or shown as such.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that although the terms first and second are used herein to describe various features or elements, these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present invention. Like numbers refer to like elements throughout.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “vehicle” includes all types of vehicles including, but not limited to, automobiles, trucks, military vehicles, airplanes, trains, etc., and also includes towed vehicles and towing vehicles.

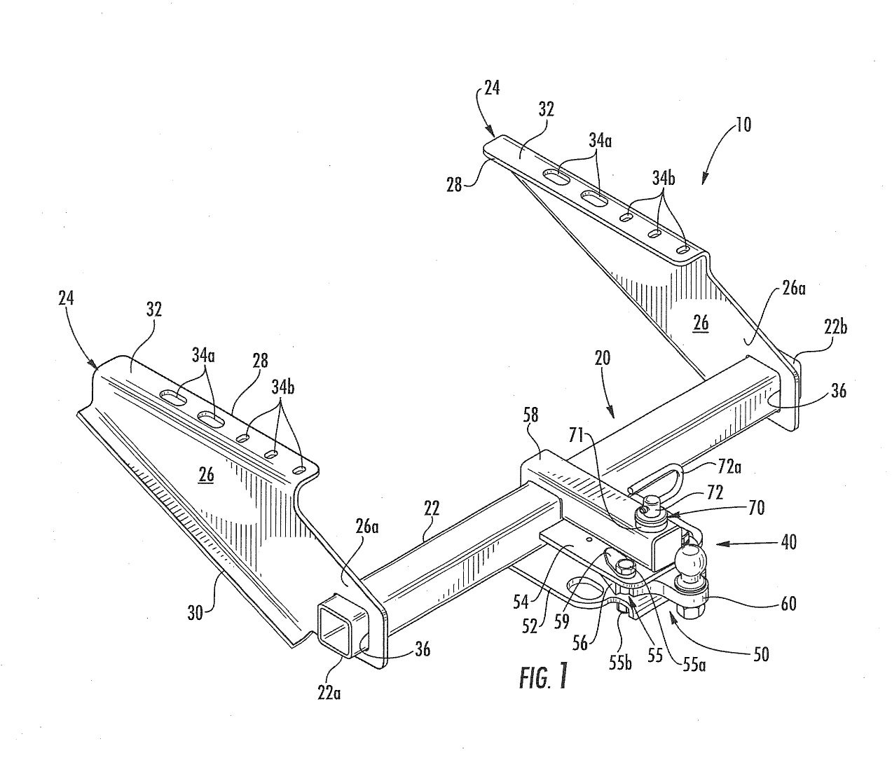

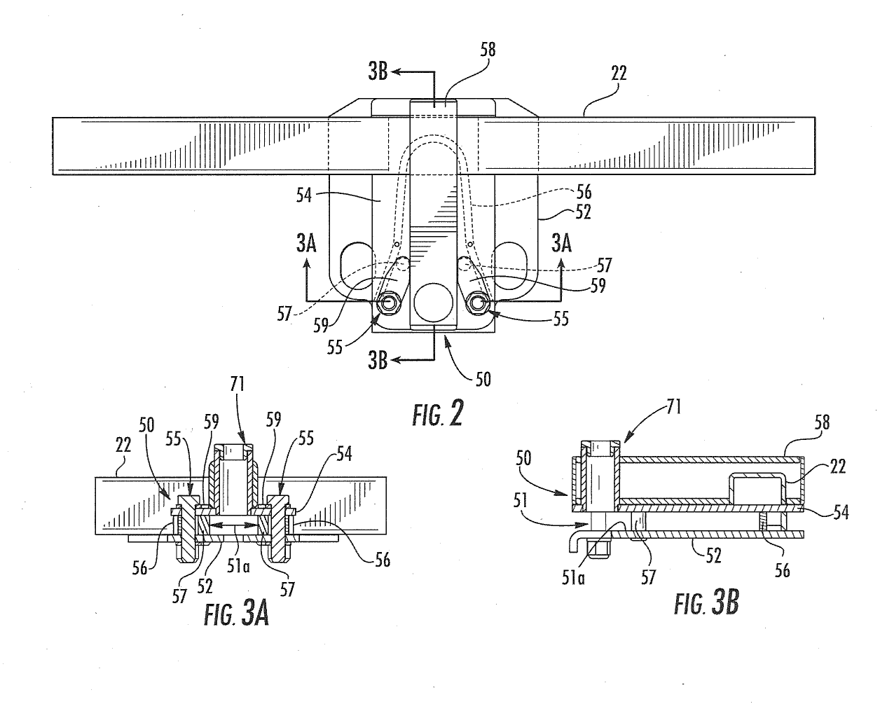

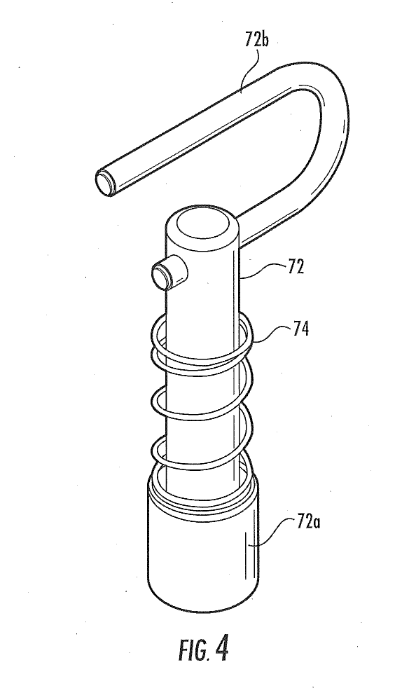

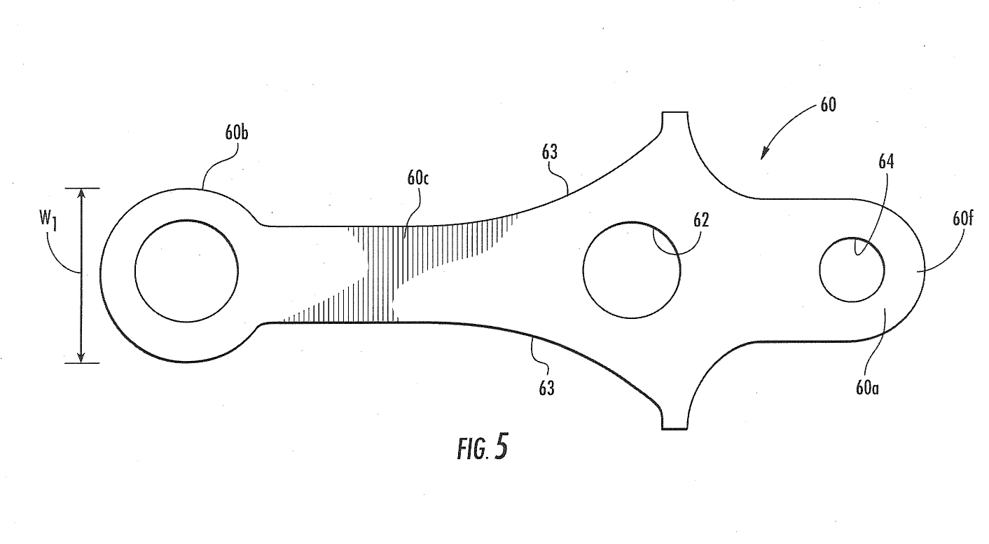

Referring now to FIGS. 1-9, a towing apparatus 10, according to some embodiments of the present invention, is illustrated. The towing apparatus 10 is configured to be installed on a vehicle, such as a pickup truck, without requiring that the spare tire be relocated and without requiring replacement of the vehicle bumper. The illustrated towing apparatus 10 includes a frame 20 and a hitch apparatus 40 secured to the frame 20. The frame 20 includes an elongated base member 22 with a generally rectangular cross section (e.g., the base member is rectangular tubing) and opposite end portions 22a, 22b. A pair of arms 24 extend away from the base member end portions 22a, 22b in side by side, spaced-apart relationship, as illustrated, to give the frame a generally U-shaped configuration.

Each arm 24 includes a substantially flat web portion 26 with an upper free edge 28 and a lower free edge 30. The upper free edge 28 is angled relative to the web portion 26 to form a bracket portion 32, as illustrated. The lower free edge 30 in the illustrated embodiment is also angled relative to the web portion 26. The angled lower edge 30 may provide structural rigidity to the arm 24 and may also help reduce the amount of space beneath a vehicle that is occupied by the frame 20. The shape of each arm 24 may be specifically designed to cooperate with the chassis/frame and/or underside of a particular vehicle model. Moreover, the shape and configuration of the free edges 30, 32 of each arm, including angles relative to the web portion 26, may be specifically designed to cooperate with the chassis/frame and/or underside of a particular vehicle model.

In the illustrated embodiment, the bracket portion 32 of each arm 24 is substantially perpendicular to the web portion 26. This configuration of the bracket portion 32 facilitates attachment of the bracket portion 32 to a surface of a vehicle chassis/frame member (or other structural member). The bracket portion 32 of each arm 24 includes a plurality of openings 34a, 34b formed therethrough. Openings 34a, 34b are sized and positioned to receive fasteners therethrough that fixedly secure each arm 24 to the chassis/frame (or other structural member) of a vehicle. The number, configuration and orientation of the openings 34a, 34b may be specifically designed for a particular vehicle. For example, these openings 34a, 34b may be aligned with respective openings (or existing fasteners) in the chassis/frame (or other structural member) of a vehicle through which new or existing fasteners (e.g., bolts, screws, threaded rods, rivets, etc.) can be inserted. Each arm 24 may also be fixedly secured to a vehicle chassis/frame (or other structural member) via welding or via a combination of welding and fasteners.

Still referring to FIG. 1, each arm 24 includes an opening 36 in an end portion 26a of the web portion 26 that is configured to receive a respective base member end portion 22a, 22b therethrough. In the illustrated embodiment, each opening 36 has a rectangular configuration to accommodate the rectangular configuration of the base member 22. The base member 22 is fixedly secured to each arm 24 via welding or fasteners or via a combination of welding and fasteners.

Embodiments of the present invention are not limited to the illustrated configuration of the arms 26 and frame base member 22. Each of these elements can have various configurations and shapes to facilitate mounting of the towing apparatus 10 to the underside of a particular vehicle. In some embodiments, base member 22 can be formed from rectangular tubing or tubing of another shape. The various components of the towing apparatus 10 can be formed from various materials known to those skilled in the art. Exemplary material for one or more components includes, but is not limited to, case-hardened steel.

The hitch apparatus 40 is secured to the base member 22 at a medial location between the two arms 24, as illustrated. The hitch apparatus 40 includes a housing 50 and a tow bar 60 movably disposed within the housing 50. The tow bar 60 is movable relative to the housing 50 between retracted and extended positions, and is pivotable relative to the housing 50 when in extended positions. The illustrated hitch apparatus housing 50 is defined by a base plate 52, an upper plate 54, and an arcuate member 56 sandwiched between the upper plate 54 and base plate 52 to form a peripheral wall of the housing. A tube member 58 is secured to frame base member 22 and to the upper plate 54, as illustrated. The tube member 58, base plate 52 and upper plate 54 are all secured to the frame base member 22, for example, via welding and/or fasteners. The base plate 52 and upper plate 54 are also secured together via fasteners 55, such as bolt 55a and nut 55b. However, other types of fasteners may be utilized, without limitation. A pair of posts 57 also extend between the upper plate 54 and base plate 52 within the housing 50 and form a restricted opening 51a that is described, below. In the illustrated embodiment, posts 57 are secured in place via respective brackets 59 that are secured to the upper plate 54 via fasteners 55.

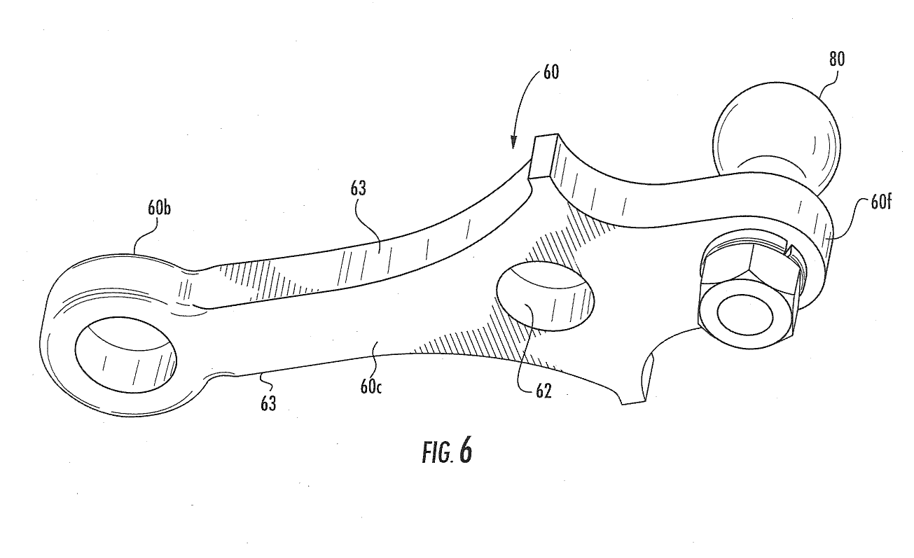

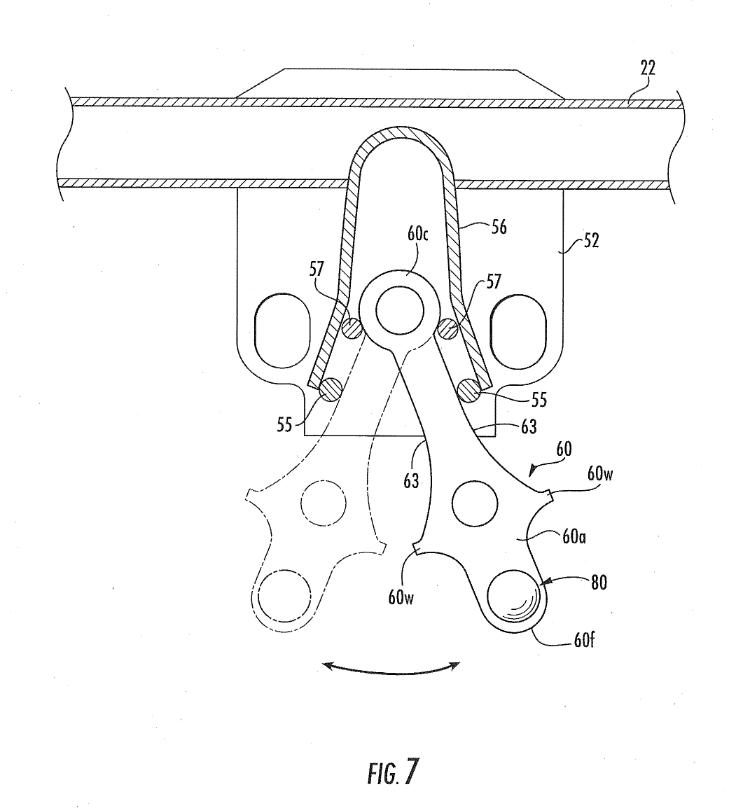

The housing 50 defines a longitudinally extending forwardly opening cavity 51 with a restricted opening 51a (defined by posts 57). As illustrated in FIG. 5, the tow bar 60 has a front portion 60a and a rear portion 60b connected by a center portion 60c. The rear portion 60b has an enlarged configuration with a width W₁ that is greater than the width of the restricted opening 51a (i.e., the distance between posts 57) and such that the rear portion 60b cannot be extended through the restricted opening 51a. The tow bar center portion 60c includes outwardly diverging curvilinear edge portions 63 that cooperate with the restricted opening 51a such that an extent to which the tow bar 60 can pivot relative to the housing 50 progressively increases as the tow bar is progressively extended and, conversely, an extent to which the tow bar 60 can pivot relative to the housing 50 progressively decreases as the tow bar 60 is progressively retracted from an extended position. The tow bar front portion 60f includes an opening 64 that is configured to receive a coupling apparatus 80, such as a tow ball (FIG. 6).

Embodiments of the present invention are not limited to the illustrated configurations of the housing 50 and tow bar 60. Other configurations may be utilized, such as those described in U.S. Pat. No. 7,584,984, which is incorporated herein by reference in its entirety.

A locking mechanism 70 (FIG. 1) is operably secured to the tube member 58 and is configured to releasably engage the tow bar 60 to maintain the tow bar 60 in a retracted position. The locking mechanism 70 includes a housing 71 that is in communication with the hitch apparatus housing cavity 51 and that extends through the tube member 58, as illustrated. A locking member 72 (FIG. 4) is movably secured within the housing 71 and is movable between a position wherein a free end 72a of the locking member 72 is inserted through the tow bar opening 62 to maintain the tow bar 60 in a fully retracted position, and a position wherein the locking member free end 72a is disengaged from the tow bar opening 62. The illustrated locking member 72 (FIG. 4) includes a handle 72b to facilitate disengaging the locking member 72 from the tow bar 60 by a user.

A biasing member 74, such as a spring, is operably associated with the locking member 72 and compressively biases the locking member 72 toward the tow bar 60. The biasing member is configured to help retain the locking member within the tow bar opening 62 when the tow bar 60 is retracted. In addition, when the locking member 72 is disengaged from tow bar opening 62 and the tow bar 60 is in any extended position, the biasing member urges the locking member 72 into contact with the upper surface 60a of the tow bar 60. When the tow bar 60 is moved back to the fully retracted position, the biasing member 74 urges the locking member 72 into the tow bar opening 62 to secure the tow bar 60 in the fully retracted position and prevent movement thereof.

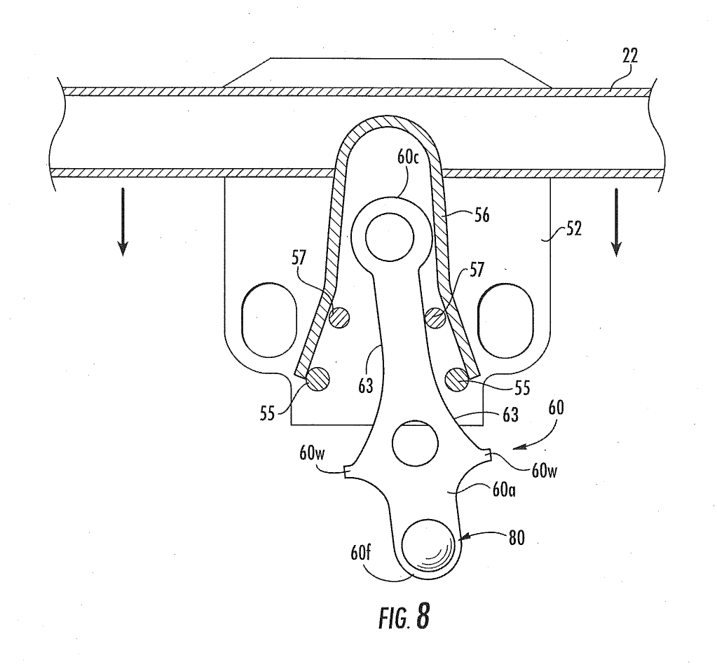

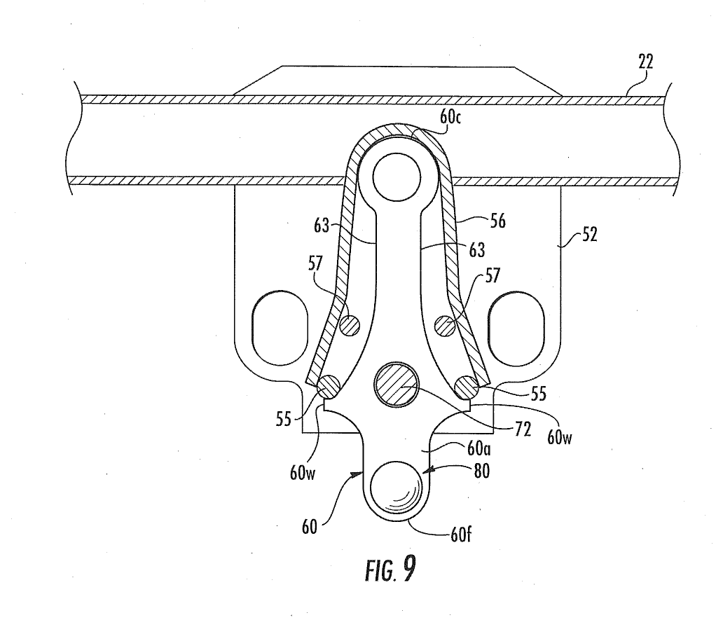

FIGS. 7-9 illustrate movement of the tow bar 60 relative to the hitch apparatus housing 50. The tow bar 60 is fully extended in FIG. 7, partially extended in FIG. 8, and fully retracted in FIG. 9. In FIG. 9, the locking member 72 is engaged with the tow bar opening 62. In FIG. 7, the tow bar 60 is fully extended and the rear portion 60b thereof cannot pass through the restricted opening 51a (i.e., between posts 57). The tow bar 60 is free to pivot from one side to another. As the tow bar 60 is extended and retracted, an edge portion 63 may contact a respective post 57 and slide therealong, as illustrated in FIG. 8. The portion of a post 57 that a respective tow bar edge portion 63 contacts may have a smooth surface to reduce friction therebetween during extension and retraction of the tow bar 60. The illustrated tow bar 60 includes wing portions 60w that contact fasteners 55 when the tow bar 60 is in the fully retracted position, as illustrated in FIG. 9.

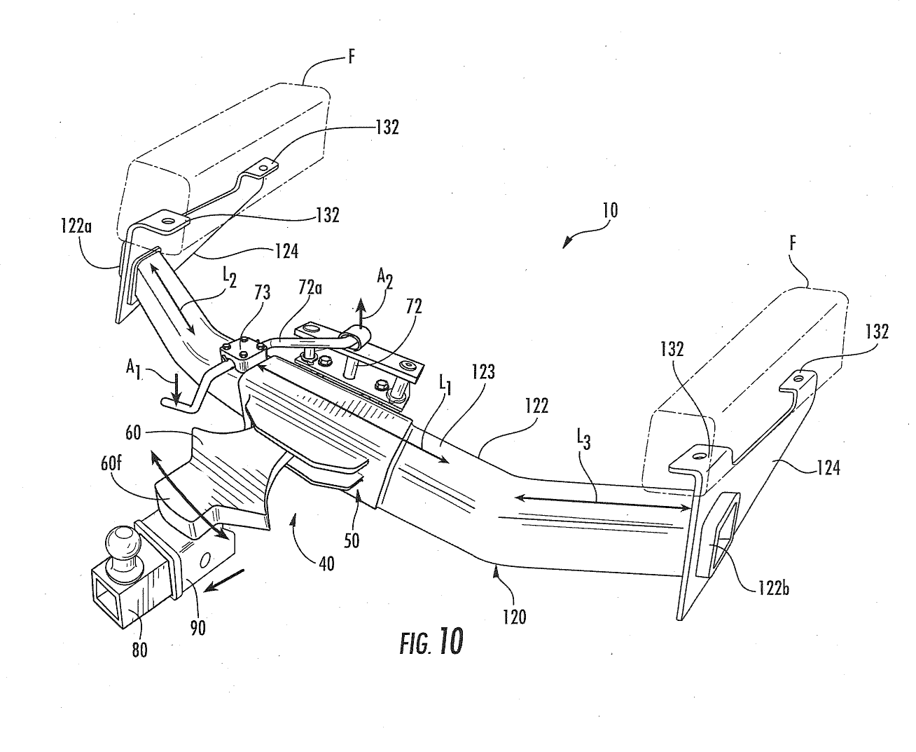

FIG. 10 illustrates a towing apparatus 10, according to other embodiments of the present invention. The towing apparatus 10 includes a frame 120 having an elongated, arcuate base member 122 and a pair of arms 124 attached to the base member and extending away from opposite end portions 122a, 122b of the base member 122 in side by side, spaced-apart relationship to give the frame 120 a generally U-shaped configuration. Each arm 124 is attached to a respective base member end portion 122a, 122b, for example via welding and/or fasteners. Each arm includes a pair of mounting brackets 132 in adjacent, spaced-apart relationship that are configured to be attached to a chassis/frame F (FIG. 12) or other structural member(s) of a vehicle without requiring the vehicle spare tire to be relocated and without requiring removal of the vehicle rear bumper B (FIG. 12). The base member 122 is a tubular member (e.g., rectangular tubing, etc.) with a medial portion 123 that defines a longitudinal direction L₁. The opposite end portions 122a, 122b extend along respective directions L₂, L₃ that are transverse to the longitudinal direction L₁ of the medial portion 123, as illustrated. It is the orientation of end portions 122a, 122b relative to the medial portion 123 that gives the illustrated base member 122 an arcuate configuration. This arcuate configuration facilitates mounting the towing apparatus 10 to a specific vehicle model.

Embodiments of the present invention are not limited to the illustrated configuration of the arms 124 and frame base member 122. Each of these elements can have various configurations and shapes to facilitate mounting of the towing apparatus 10 to the underside of a particular vehicle. In some embodiments, base member 122 can be formed from rectangular tubing or tubing of another shape. The various components of the towing apparatus 10 of FIG. 10 can be formed from various materials known to those skilled in the art. Exemplary material for one or more components includes, but is not limited to, case-hardened steel.

A hitch apparatus 40 is secured to the base member medial portion 123. The hitch apparatus 40 includes a housing 50 and a tow bar 60 movably disposed within the housing 50, as described above with respect to the embodiments illustrated in FIGS. 1-9. In the illustrated embodiment of FIG. 10, a hitch box 90 is secured to the tow bar front portion 60f and is configured to receive a coupling apparatus 80 therein.

A locking member 72 is operably secured to the frame 120 and is configured to releasably engage the tow bar 60 and maintain the tow bar in a fully retracted position. The locking member 72 is located relative to the housing 50 such that the locking member 72 engages with an opening 62 in the center portion 60c of the tow bar 60. In the illustrated embodiment of FIG. 10, the locking member includes an elongated handle 72a that is movably secured to the frame 120. The handle 72a is configured to disengage the locking member 72 from the tow bar 60 in response to user activation (indicated by arrow A₁). The illustrated handle 72a is rotatably secured within housing 73 such that downward movement of one end of the handle, as indicated by arrow A1, causes the opposite end of the handle to move upwardly (indicated by arrow A2). This upwardly movement raises the locking member 72 and disengages the locking member 72 from the tow bar 60.

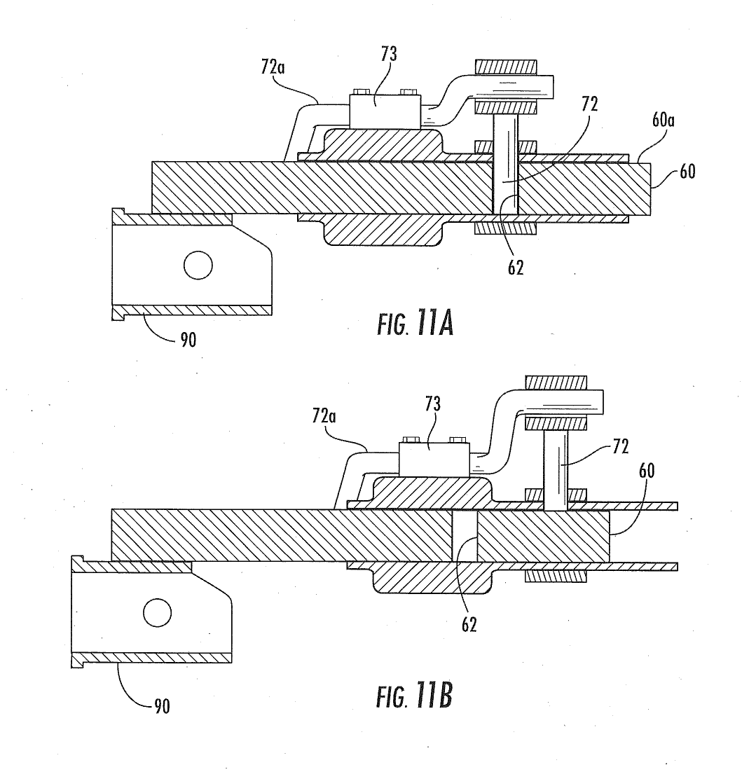

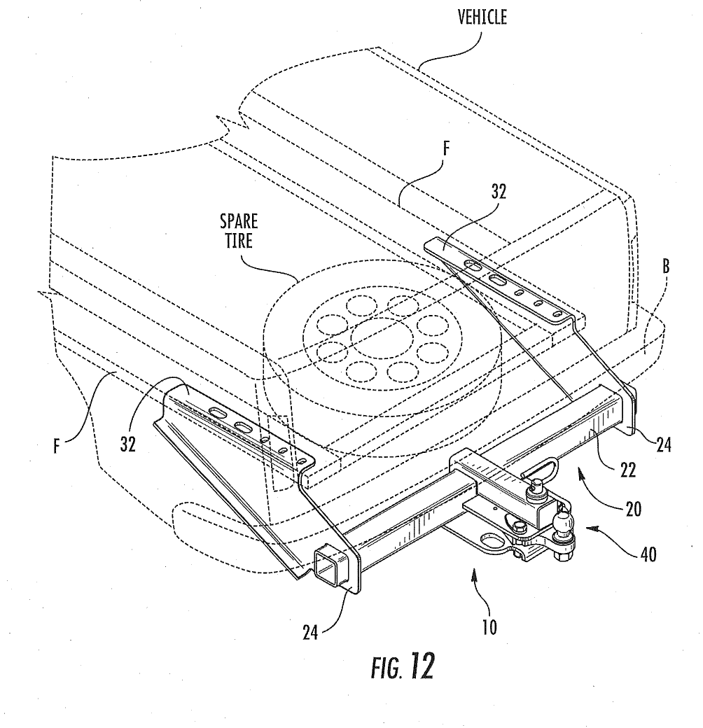

FIG. 11A illustrates the tow bar 60 fully retracted and the locking member engaged within an opening 62 in the tow bar 60. FIG. 11B illustrates the tow bar in an extended position. A biasing member (not shown) is operably associated with the locking member 72 and compressively biases the locking member 72 toward the tow bar 60. The biasing member is configured to help retain the locking member within tow bar opening 62 when the tow bar 60 is fully retracted. In addition, when the locking member 72 is disengaged from tow bar opening 62 and the tow bar 60 is extended, the biasing member urges the locking member 72 into contact with the upper surface 60a of the tow bar 60, as illustrated in FIG. 11B.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed is:

1. A towing apparatus, comprising:
a frame comprising an elongated base member having opposite end portions, and a pair of arms extending away from the base member end portions in side by side, spaced-apart relationship, wherein each arm includes a mounting bracket configured to be attached to a frame of a vehicle; and
a hitch apparatus secured to the base member, wherein the hitch apparatus comprises a housing and a tow bar movably disposed within the housing, wherein the tow bar is movable relative to the housing between retracted and extended positions, and is pivotable relative to the housing when in an extended position.

2. The towing apparatus of claim 1, further comprising a locking member operably secured to the frame that releasably engages the tow bar to maintain the tow bar in a retracted position.

3. The towing apparatus of claim 2, wherein the tow bar has an opening formed therethrough, and Wherein locking member is retractably extendable through the opening to maintain the tow bar in a retracted position.

4. The towing apparatus of claim 3, further comprising a biasing member that compressively biases the locking member toward the tow bar.

5. The towing apparatus of claim 4, wherein the locking member engages a surface of the tow bar when the locking member is retracted from the opening and the tow bar is extended.

6. The towing apparatus of claim 3, wherein the locking member comprises a handle.

7. The towing apparatus of claim 6, wherein the handle is movably secured to the frame and is configured to disengage the locking member from the tow bar in response to user activation.

8. The towing apparatus of claim 1, wherein the housing comprises a longitudinally extending forwardly opening cavity with a restricted opening, wherein the tow bar comprises a front portion and a rear portion connected by a center portion, the rear portion having a width greater than the restricted opening such that the rear portion cannot be extended through the opening.

9. The towing apparatus of claim 8, wherein the center portion comprises outwardly diverging curvilinear edge portions that cooperate with the restricted opening such that an extent to which the tow bar can pivot relative to the housing progressively increases as the tow bar is progressively extended.

10. The towing apparatus of claim 1, wherein the mounting bracket of each arm comprises a plurality of apertures formed therein.

11. The towing apparatus of claim 1, wherein each arm comprises two mounting brackets in adjacent, spaced-apart relationship.

12. The towing apparatus of claim 1, wherein a hitch box is secured to the tow bar front portion, wherein the hitch box is configured to receive a coupling apparatus therein.

13. The towing apparatus of claim 8, wherein the tow bar front portion includes an opening formed therethrough, and further comprising a coupling apparatus secured to the tow bar via the opening.

14. The towing apparatus of claim 1, wherein each arm comprises an opening, and wherein a respective base member end portion extends through the opening of a respective arm.

15. The towing apparatus of claim 1, wherein each arm comprises a substantially flat web portion with a free edge portion that is angled to form the mounting bracket, and wherein the mounting bracket comprises at least one opening therein.

16. The towing apparatus of claim 15, wherein the free edge portion of each web portion is elevated above the base member.

17. The towing apparatus of claim 15, wherein the mounting bracket of each arm is substantially perpendicular to the web portion.

18. The towing apparatus of claim 8, wherein a hitch box is secured to the tow bar front portion, wherein the hitch box is configured to receive a coupling apparatus therein.

19. The towing apparatus of claim 1, wherein the base member has an arcuate configuration.

20. The towing apparatus of claim 1, wherein the base member comprises a medial portion that defines a first longitudinal direction, and wherein the opposite end portions extend along respective second and third longitudinal directions that are transverse to the first longitudinal direction.

21. A towing apparatus, comprising:
a U-shaped frame comprising an elongated base member having opposite end portions, and a pair of arms extending away from the base member end portions in side by side, spaced-apart relationship, wherein each arm comprises a substantially flat web portion with a free edge portion that is angled to form a mounting bracket configured to be attached to a frame of a vehicle, wherein the web portion of each arm comprises an opening, and wherein a respective base member end portion extends through the opening of a respective arm; and
a hitch apparatus secured to the base member, wherein the hitch apparatus comprises a housing and a tow bar movably disposed within the housing, wherein the tow bar is movable relative to the housing between retracted and extended positions, and is pivotable relative to the housing when in an extended position.

22. The towing apparatus of claim 21, further comprising a locking member operably secured to the frame that releasably engages the tow bar to maintain the tow bar in a retracted position.

23. The towing apparatus of claim 22, wherein the locking member comprises a handle.

24. The towing apparatus of claim 23, wherein the handle is movably secured to the frame and is configured to disengage the locking member from the tow bar in response to user activation.

25. The towing apparatus of claim 21, wherein the base member comprises rectangular tubing.

26. The towing apparatus of claim 21, wherein the base member has an arcuate configuration.

27. The towing apparatus of claim 21, wherein the base member comprises a medial portion that defines a first longitudinal direction, and wherein the opposite end portions extend along respective second and third longitudinal directions that are transverse to the first longitudinal direction.

28. A vehicle, comprising:
a body;
a spare tire removably mounted to an underside of the vehicle body; and
a towing apparatus secured to the underside of the vehicle, wherein the towing apparatus comprises:
a frame comprising an elongated base member having opposite end portions, and a pair of arms extending away from the base member end portions in side by side, spaced-apart relationship such that the frame has a U-shaped configuration that extends around the spare tire such that the spare tire can be accessed without interference, wherein each arm includes a mounting bracket attached to the underside of the vehicle; and
a hitch apparatus secured to the base member, wherein the hitch apparatus comprises a housing and a tow bar movably disposed within the housing, wherein the tow bar is movable relative to the housing between retracted and extended positions, and is pivotable relative to the housing when in an extended position.

29. The vehicle of claim 28, wherein the housing comprises a longitudinally extending forwardly opening cavity with a restricted opening, wherein the tow bar comprises a front portion and a rear portion connected by a center portion, the rear portion having a width greater than the restricted opening such that the rear portion cannot be extended through the opening.

30. The vehicle of claim 29, wherein the center portion comprises outwardly diverging curvilinear edge portions that cooperate with the restricted opening such that an extent to which the tow bar can pivot relative to the housing progressively increases as the tow bar is progressively extended.
